(19) United States
(12) Patent Application Publication
(10) Pub. No.: US 2015/0363881 A1
(43) Pub. Date: Dec. 17, 2015

(54) Program and Method for Investing Cooperatively in the Property of Wholesale Goods

(71) Applicant: Hubert P Nicholas, Brooklyn, NY (US)

(72) Inventor: Hubert P Nicholas, Brooklyn, NY (US)

(21) Appl. No.: 14/302,145

(22) Filed: Jun. 11, 2014

(51) Int. Cl. G06Q 40/06

(52) U.S. Cl. CPC G06Q 40/06

(57) ABSTRACT

This invention is for a cooperative investment program. For this cooperative investment program, the credit union and bank's administrators operate the software program that houses the method of investing in the property of wholesale consumer goods. The administrators organize the program of investing in the goods by dividing the goods into four departments, which are groceries, clothing, computer electronics and automobiles. The credit union and bank manages the investors' monthly investments and the compensation for investing in the property of wholesale consumer goods. The credit union uses the money as the financial engine that opens the cooperatively owned stores and buys the goods that go in these stores. The credit unions and banks are also the campaign hubs that organize the marketing and recruitment for the investment program and its method which is the Force Matrix used to invest in these four areas of the property of wholesale consumer goods.

### CROSS REFERENCE TO RELATED APPLICATION

This non-provisional patent application claims priority to U.S. Provisional Patent Application No. 61/833,766 filed on Jun. 11, 2013, which application is incorporated herein by reference.

### FIELD OF THE INVENTION

The disclosed technology relates to an investment product for banks and credit unions.

### BACKGROUND OF THE INVENTION

This investment program is our intellectual property. The investment is in the property of wholesale consumer goods. The Force Matrix is the method used to invest in this property. By using this method to cooperatively invest in the property of wholesale consumer goods, we have created a discount membership assurance program. By taking on the responsibility of the monthly investment and utilizing the Force Matrix, each investor is an authorized seller of the discount membership assurance. Investors who sell this investing membership to other investors will be compensated monthly, by both the sale of consumer memberships and the sale of investing memberships. The sell and benefit of membership is what differentiates this program from an illegal pyramid. The way investors and customer members can tell whether the discount assurance membership is legitimate is by checking prices in retail stores in the consumer goods area in which they have a membership. We believe our cooperative method of investing in wholesale consumer goods utilizing the Force Matrix Method can become a common and viable alternative to many traditional investments like the stock market and time contracted investments like CD's, 401(K)'s, Bonds and Pension programs. The force matrix serves as the acceleration pedal for this investment program; it is where the selling of memberships and compensation for the sale of membership takes place. This investment program is not passive but is an aggressive investment program that gives investors control to dictate when they want to achieve financial goals.

### SUMMARY OF THE INVENTION

The present invention has been accomplished in view of the above-mentioned technical background, and it is an object of the present invention to provide a system for creating a cooperative investment program for a credit union and a bank.

For this cooperative investment program, the credit union and bank's administrators operate the software program that houses the method of investing in the property of wholesale consumer goods. The administrators organize the program of investing in the goods by dividing the goods into four departments, which are groceries, clothing, computer electronics and automobiles. The credit union and bank manages the investors' monthly investments and the compensation for investing in the property of wholesale consumer goods. The credit union uses the money as the financial engine that opens the cooperatively owned stores and buys the goods that go in these stores. The credit unions and banks are also the campaign hubs that organize the marketing and recruitment for the investment program and its method which is the Force Matrix used to invest in these four areas of the property of wholesale consumer goods.

### BRIEF DESCRIPTION OF THE DRAWINGS

FIG. 1 is a diagram of how the program and method for investing cooperatively in the property of wholesale consumer goods works in accordance with the invention;

FIGS. 2A and 2B shows flow-charts of how the program and method for investing cooperatively in the property of wholesale consumer goods is utilized in accordance with the invention; and

FIG. 3 shows a diagram of a cooperative investment structure in accordance with the invention.

### DETAILED DESCRIPTION OF THE INVENTION

The presently preferred embodiments of the invention are described with reference to the drawings, where like components are identified with the same numerals. The descriptions of the preferred embodiments are exemplary and are not intended to limit the scope of the invention.

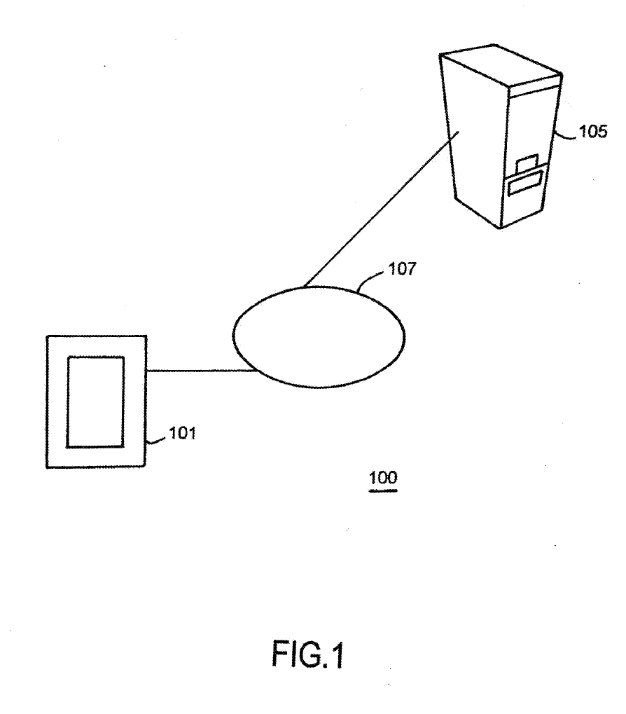

FIG. 1 is a diagram of how the program and method for investing cooperatively in the property of wholesale consumer goods works. The investment cooperative system 100 includes: an first computer 101, a web interface 103 and an second computer 105. First computer 101 is connected through a communication link, such as web Interface 103 to the second computer 105. The communication link may be a local access network (LAN), wireless access network, wide area network (WAN), a virtual area network, wireless fidelity (Wi-Fi) network, Bluetooth, an Ethernet link, a satellite link, cable link, cellular, fiber-optic or any network that can facilitate the transfer of information between computer systems. The first computer 101 includes an actual person/consumer that utilizes the first computer 101. First computer 101 may be any type of computer system including a desktop, laptop, notebook, mobile computer system, a tablet computing system, cell phone, smartphone, mobile phone or any type of computing system. This first computer 101 is connected to web Interface 103, which connects it to the second computer 105. First computer 101 is only a tangible medium for accessing the investment program stored on the second computer 105. This first computer 101 is simply a means for accessing the investment program stored on the second computer 105.

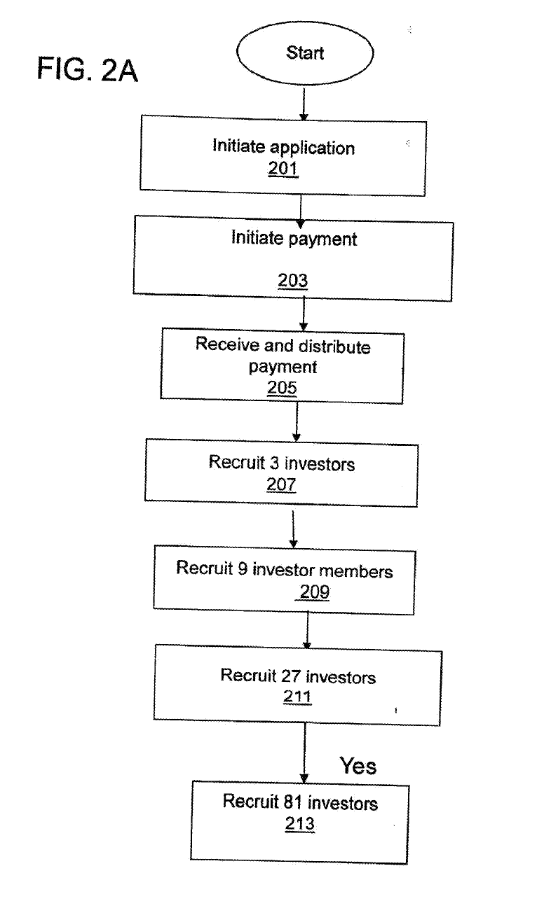

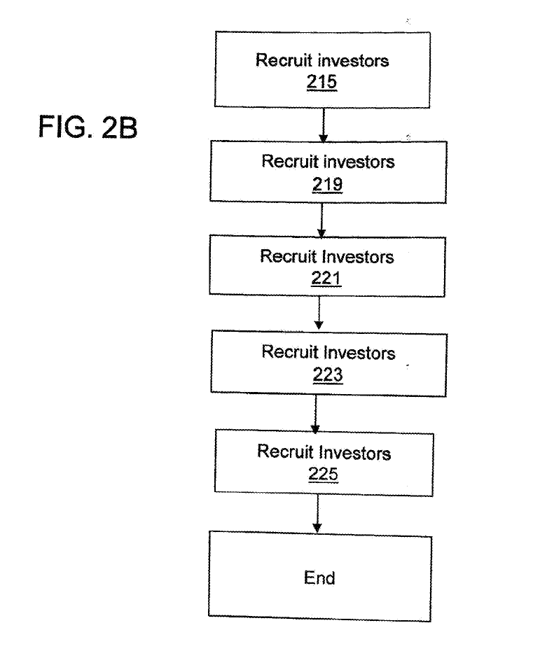

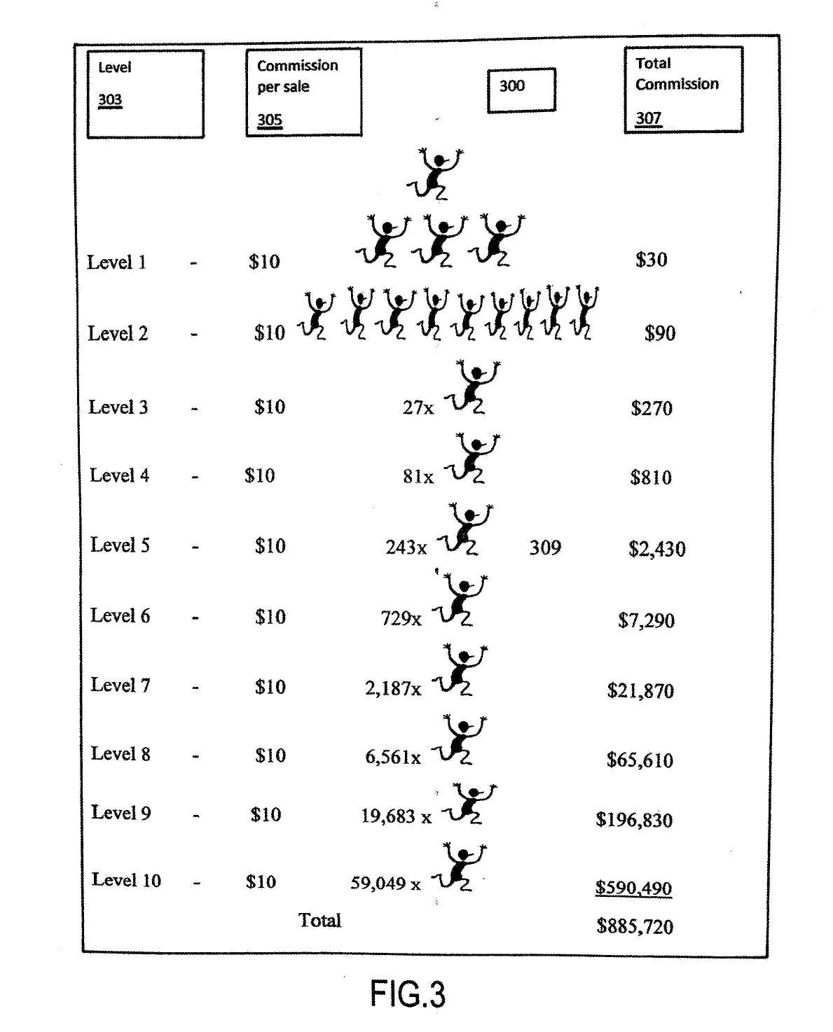

The second computer 105 is equivalent to a typical merchant server or computer system that includes a processor, mass storage and memory. Second computer 105 also includes a special application program or algorithm stored on the processor which will be described in FIGS. 2A and 2B, and FIG. 3. The special application program is a program and method for investing cooperatively in the property of wholesale goods or investment program. Keep in mind the second computer 105 is a tangible means to store the investment program. This investment program can be stored on a tangible medium such as CD or DVD. Typical software programs are a set of programs, procedures, algorithms and documentation which are integral to the operation of a data processing system. This investment structure or investment program is run by a credit union whereby the monthly fee payments made by the investors are received by the credit union to support this investment structure. This investment program is stored on the second computer 105 of the credit union. A membership is provided to any investor that enrolls in the cooperative investment program. The members' transactions associated with their purchases may be stored on a non-transitory storage medium and/or communicated via network nodes which are routers or switches receiving and forwarding or retransmitting data received.

The structure disclosed here is utilized to operate a cooperative store or department store as an investment vehicle where the investors monthly payment goes into the: 1. infrastructure associated with the store such as lights, electricity, mortgage, real estate taxes, 2. Products purchased by the store and 3. Compensation plan for the investors. The cooperative store includes 4 separate departments that includes: 1. Groceries, 2. Automobiles, 3. Men/Women and children apparel and 4. Computer Electronics. This investment vehicle enables the investor to cooperatively build and operate a store from the ground up as an investment, purchase store products, receive deep discounts from purchasing store products and receive residual income from recruiting other investor members. An investor member starts with one department then uses all four departments of the cooperative store as an investment vehicle. In another embodiment of the invention, there may be other departments utilized such as office equipment department, furniture department, housewares department and any other typical goods sold in a department store. When the investor member becomes a shepherd level in a particular department then he must cross-cooperate with other shepherd level investor members at the other respective departments to then become a shepherd level of the other respective departments. The term “shepherd level” is defined differently for each department as discussed below.

FIG. 2A is a flow chart of how the program and method for investing in a cooperatively in the property of wholesale consumer goods is utilized in accordance with invention. At block 201, an initial investor 300 utilizes first computer 101 by going to a website of a credit union or bank that utilizes this investment program, where the investor accesses, initiates and enrolls in this investment program stored on the second computer 105. This particular portion of the investment program is relevant to the groceries department, but it may start at the computer electronic department, Auto leasing department or the men/women and Children's apparel department depending on where the investor member 300 wants to initiate the program. The first computer 101 transmits a message through the web interface 103 to access the investment program stored on the second computer 105 at the credit union. At block 203, after gaining access to the investment program the initial investor 300 makes an initial payment to join the investment cooperative structure. (FIG. 3). FIG. 3 represents a force matrix. A “force matrix” is a commission structure whereby each member/investor is limited to recruiting a finite, fixed number of new members to buy/invest in the property of wholesale goods or the property of consumer goods. More particularly, the structure shown in FIG. 3 represents a three by ten force matrix. That is, each member is limited to directly recruiting three new members. Those three new members are in turn limited to recruiting three new members of their choosing, and so forth down through the levels of recruitment until ten levels of recruitment are reached. Thus, the initial investor may be paid commission on all levels of recruitment until the ten levels are filled. As each subsequent level is filled, the initial investor earns an exponentially greater commission. Even the three by ten force matrix is utilized this invention may use any type of force matrix such as four by ten force matrix or five by eight matrix or any applicable force matrix. The payment may be a one-time payment, or a periodical payment that can be paid every week, month, and/or year. For this example, the payment is made monthly where the investor pays a monthly fee of $280.00 that is distributed to the credit union. In another embodiment of the invention, the Men/women and children apparel department has a monthly fee of $280.00 per month. In yet another embodiment of the invention, the Auto department and the computer electronic department has a monthly payment fee of $340.00.

Referring to FIG. 2A, at block 205 the credit union at the investment cooperative server 205 receives and distributes the money it receives in three ways: 1. $80.00 to purchase the product, 2. $100.00 that goes directly to the credit union and 3. $100.00 that goes into the compensation plan. The $80.00 is utilized to purchase the products associated with the store, such as items found in a grocery store including milk, cereal, bread, cheese, water etc. The $100.00 goes to take care of the infrastructure of the store while $100.00 is the compensation plan paid out to the investor members. Even though the money is split in three different ways with certain denominations this is only an example how the credit union or bank may split up the distribution in any way that it sees fit. In another embodiment of the invention, for the Men/Women and children apparel department the payment is split in the following ways: 1. $80.00 to purchase the product, 2. $100.00 that goes directly to the credit union and 3. $100.00 that goes into the compensation plan. The $80.00 is utilized to purchase the product associated with the store, such as men/women and children apparel. The $100.00 goes to take care of the infrastructure of the store while $100.00 is the compensation plan paid out to the investor members.

In yet another embodiment invention, for the Auto department and the computer electronic department the payment is split in the following ways: 1. $140.00 to purchase the product, 2. $100.00 that goes directly to the credit union and 3. $100.00 that goes into the compensation plan. The $140.00 is utilized to lease to purchase an automobile or purchase a tire, or mat associated with the automobile store. The $100.00 goes to take care of the infrastructure of the store while $100.00 is the compensation plan paid out to the investor members. [0016] This initial investment provides the initial investor member 300 with ownership of the store, the ability to determine the products in the store and a compensation for obtaining other investment members. The investor may have a discount in a range of 20-50% off the normal price of the grocery goods sold at the store, which promotes commerce at the store. The initial investor 300 is also given an incentive to recruit and enlist more individuals to become investor members in the cooperative investment structure. The initial investor 300 will receive a $10 commission per person he recruits to be an investment member. Each investor, including the initial investor 300 or investor member, may be limited to recruiting three investor members directly as per the force matrix.

Returning to FIG. 2A, at block 207, the initial investor member 300 recruit three primary investor members as shown in level 1 (first set of investors) of the hierarchy of levels 303 as per the force matrix. (FIG. 3). When the three primary investor members are recruited each of them sends their payments through their own first computer 101 through the web interface 103 to the second computer 105 at the credit union. Thus, for recruiting the three primary investor members, the initial investor member 300 receives $30 at $10.00 per person. As stated above, the credit union receives $280.00 from each of the three primary investor members where for each person the credit union is splitting the money received $80.00 to purchase the grocery product, $100.00 directly to the credit union for infrastructure and $100.00 to the Compensation plan. The credit union uses the $100.00 Compensation plan to provide the primary investor member 300 and all subsequent investor members that gets other investor members $10.00 commission per month. This commission is stored in an account for the investor member 300 and all subsequent investor members. However, this is not the limit of the initial investor members' earning potential. For each investor members' subsequently enlisted by any of the three primary investor members, the initial investor 300 will receive another $10 commission per sale 305. Thus, if each level 1 primary investor member recruits three level 2 secondary investors (for a total of nine secondary investors), the initial investor will get an additional $90 in commission for a total commission 307, while the primary three investors will each receive $30 in commission.

Returning to FIG. 2A, at block 209, the three primary investor members each recruits three members for a total of nine investor members as shown in level 2 (second set of investors) of the hierarchy of levels 303 as per the force matrix. (FIG. 3). When the nine investor members are recruited each of them sends their payments through their own first computer 101 through the web interface 103 to the second computer 105 at the credit union and bank. Thus, for recruiting the nine investor members, the initial investor member 300 receives $90 at $10.00 per person. As stated above, the credit union receives $280.00 from each of the nine investor members where for each person the credit union or bank is splitting the money received $80.00 to purchase the grocery product, $100.00 directly to the credit union for infrastructure and $100.00 to the Compensation plan. The credit union or bank uses the $100.00 Compensation plan to provide the primary investor member 300 and all subsequent investor members that gets other investor members $10.00 commission per month.

Next, at block 211, the nine investor members each recruit three investor members to recruit a total of twenty seven investor members as shown in level 3 (third set of investors) of the hierarchy of levels 303 as per the force matrix. (FIG. 3). When the twenty seven investor members are recruited each of them sends their payments through their own first computer 101 through the web interface 103 to the second computer 105 at the credit union or bank. Thus, for recruiting the twenty seven investor members, the initial investor member 300 receives $270 at $10.00 per person for a total commission 307. As stated above, the credit union or bank receives $280.00 from each of the twenty seven investor members where for each person the credit union or bank is splitting the money received $80.00 to purchase the grocery product. $100.00 directly to the credit union for infrastructure and $100.00 to the Compensation plan. The credit union or bank uses the $100.00 Compensation plan to provide the primary investor member 300 and all subsequent investor members that gets other investor members $10.00 commission per month.

Referring to FIG. 2A, at block 213, the twenty seven investor members each recruit three investor members to recruit a total of 81 investor members as shown in level 4 (fourth set of investors) of the hierarchy of levels 303 as per the force matrix. (FIG. 3). When the 81 investor members are recruited each of them sends their payments through their own first computer 101 through the web interface 103 to the second computer 105 at the credit union or bank. Thus, for recruiting the 81 investor members, the initial investor member 300 receives $810 at $10.00 per person for a total commission 307. As stated above, the credit union receives $80.00 from each of the 81 investor members where for each person the credit union is splitting the money received $80.00 to purchase the grocery product. $100.00 directly to the credit union for infrastructure and $100.00 to the Compensation plan. The credit union or bank uses the $100.00 Compensation plan to provide the primary investor member 300 and all subsequent investor members that gets other investor members $10.00 commission per month.

Returning to FIG. 2B, at block 215, the 81 investor members each recruit three investor members for a total of 243 investor members as shown in level 5 (fifth set of investors) of the hierarchy of levels 303 as per the force matrix. (FIG. 3). When the 243 investor members are recruited each of them sends their payments through their own first computer 101 through the web interface 103 to the second computer 105 at the credit union or bank. Thus, for recruiting the 243 investor members, the initial investor member 300 receives $2.430.00 at $10.00 per person for a total commission 307. As stated above, the credit union or bank receives $80.00 from each of the 243 investor members where for each person the credit union or bank is splitting the money received $80.00 to purchase the grocery product, $100.00 directly to the credit union for infrastructure and $100.00 to the Compensation plan. The credit union or bank uses the $100.00 Compensation plan to provide the primary investor member 300 and all subsequent investor members that gets other investor members $10.00 commission per month.

Returning to FIG. 2B, at block 217, the 243 investor members each recruit three investor members for a total of 729 investor members as shown in level 6 (sixth set of investors) of the hierarchy of levels 303 as per the force matrix. (FIG. 3). When the 243 investor members are recruited each of them sends their payments through their own first computer 101 through the web interface 103 to the second computer 105 at the credit union or bank. Thus, for recruiting the 729 investor members, the initial investor member 300 receives $7.290 at $10.00 per person for a total commission 307. As stated above, the credit union or bank receives $280.00 from each of the 729 investor members where for each person the credit union is splitting the money received $80.00 to purchase the grocery product, $100.00 directly to the credit union or bank for infrastructure and $100.00 to the Compensation plan. The credit union or bank uses the $100.00 Compensation plan to provide the primary investor member 300 and all subsequent investor members that gets other investor members $10.00 commission per month.

The investor member 300 who has reached “shepherd” level 309 for the groceries department where he has recruited 500 members, then he may go to the next stage of having customer members. This method allows the investor member 300 to serve customer members with an exclusive discount membership that enables them to shop the network in the cooperative store at significantly low daily prices for a monthly fee. For every 70 investing members after the investor member 300 reaches the shepherd level 309 the investor member is able to serve 3 customer members with the exclusive discount membership assurance for a $25.00 a month fee. The customer members unlike the investor members are not able to use the cooperative store as an investment vehicle, because they will be paying $25.00 a month to be a customer member where this $25.00 will go to the credit union or bank and directly to the shepherd who brought in the customer members. For each multiple of 70 investor members brought in by the shepherd level 309 investor member he is allowed to bring in 3 customer members. Thus, when the shepherd level 309 investor member brings in 70 investor members, then 3 customer members can brought in. Next, when the shepherd bring in a second group of 70 investor members, then 3 customers can be brought in. Further, when the shepherd level 309 investor member brings in a third group of 70 investor members then, 3 customers members can be brought in for a total of 210 investing members and 9 customer members being brought into the system. These customer members will also receive discounts from shopping for groceries at the cooperative store in any range between 20-40%. Next, after the investor members and customer members the cooperative store allows regular people to shop at the store where they will receive a discount in the range of 10-15% off of purchased products. In another embodiment of the invention, the investor member 300 who has reached “shepherd” level 309 for the auto department where he has recruited 385 members, then he can obtain lease to own vehicles for significant discounts.

Returning to FIG. 2A, at block 219, the 729 investor members each recruit three investor members for a total of 2,187 investor members as shown in level 7 (seventh set of investors) of the hierarchy of levels 303 as per the force matrix. (FIG. 3). When the 2,187 investor members are recruited each of them sends their payments through their own first computer 101 through the web interface 103 to the second computer 105 at the credit union. Thus, for recruiting the 2,187 investor members, the initial investor member 300 receives $21,870 at $10.00 per person for a total commission 307. As stated above, the credit union receives $280.00 from each of the 2187 investor members where for each person the credit union is splitting the money received $80.00 to purchase the grocery product. $100.00 directly to the credit union for infrastructure and $100.00 to the Compensation plan. The credit union uses the $100.00 Compensation plan to provide the primary investor member 300 and all subsequent investor members that gets other investor members $10.00 commission per month.

In another embodiment of this invention, with respect to the investor member for Men/Women and children apparel and computer electronics departments he would be at the “shepherd” level because he has recruited 750 investor members, then he may optionally go to the next stage of having customer members. For every 70 investing members after the investor member reaches the shepherd level the investor member is able to serve 3 customer members with the exclusive discount membership assurance for a $25.00 a month fee, where the customer members receive a 25-50% discount on men/women and children's apparel or computer electronics. The customer members unlike the investor members are not able to use the cooperative store as an investment vehicle, because they will be paying $25.00 a month to be a customer member where this $25.00 will go to the credit union and directly to the shepherd who brought in the customer members. For each multiple of 70 investing members brought in by the shepherd level investor member he is allowed to bring in 3 customer members. Thus, when the shepherd level investor member brings in 70 investing members, then 3 customer members can be brought in. Next, when the shepherd level investor member brings in a second group of 70 investor members, then 3 customer members can be brought in. Further, when the shepherd brings in a third group of 70 members then, 3 customers members can be brought in for a total of 210 investing members and 9 customer members being brought into the system. These customer members will also receive discounts from shopping for groceries at the store in any range between 20-40%.

In yet another embodiment of the invention, the investor member would've reached the “shepherd” level 309 for the Autos department because he has reached 1.125 investor members below him. When the investor member has 1,125 people below him he is at the “shepherd” level 309. The shepherd level 309 as shown in FIG. 3 occurs between the levels of 6 and 7. Since this investor member has 1,125 people below him he'll be earning $11,250.00 a month, where the 1.125 people are paying $340.00 each where the $100.00 is used as part of the compensation plan. From this compensation plan $10.00 is taken out from subsequent investor member monthly fee and paid to the investor member at the shepherd level.

The commission structure gives an incentive to investors to promote the membership benefits of the cooperative investment program, while it benefits the participating merchants by increasing the number of consumers who will become the merchant's customers. After the investor member reaches the “shepherd” level 309 for the Auto department where he has recruited 1,125 members, then he may go to the next stage of having customer members. For every 70 investing members after the investor member reaches the shepherd level the investor member is able to serve 3 customer members with the exclusive discount membership assurance for a $25.00 a month fee, where the customer members receive a 25-40% discount on Auto department. The customer members unlike the investor members are not able to use the cooperative store as an investment vehicle, because they will be paying $25.00 a month to be a customer member where this $25.00 will go to the credit union and directly to the shepherd who brought in the customer members. For each multiple of 70 investing members brought in by the shepherd he is allowed to bring in 3 customer members. Thus, when the shepherd investing member brings in 70 investing members, then 3 customer members can be brought in. Next, when the shepherd level 309 investor member brings in a second group of 70 investing members, then 3 customer members can be brought in. Further, when the shepherd brings in a third group of 70 members then, 3 customers members can be brought in for a total of 210 investing members and 9 customer members being brought into the system.

Returning to FIG. 2B, at block 221, the 2,187 investor members each recruit three investor members for a total of 6,561 investor members as shown in level 8 (eight set of investors) of the hierarchy of levels 303 as per the force matrix. (FIG. 3). When the 6.561 investor members are recruited each of them sends their payments through their own first computer 101 through the web interface 103 to the second computer 105 at the credit union. Thus, for recruiting the 6,561 investor members, the initial investor member 300 receives $65,610 at $10.00 per person for a total commission 307. As stated above, the credit union receives $280.00 from each of the 6,561 investor members where for each person the credit union is splitting the money received $80.00 to purchase the grocery product, $100.00 directly to the credit union for infrastructure and $100.00 to the Compensation plan. The credit union uses the $100.00 Compensation plan to provide the primary investor member 300 and all subsequent investor members that gets other investor members $10.00 commission per month. [0029] Referring to FIG. 2B, at block 223, the 6,561 investor members each recruit three investor members for a total of 19,683 investor members as shown in level 9 (ninth set of investors) of the hierarchy of levels 303 as per the force matrix. (FIG. 3). When the 19.683 investor members are recruited each of them sends their payments through their own first computer 101 through the web interface 103 to the second computer 105 at the credit union. Thus, for recruiting the 19.683 investor members, the initial investor member 300 receives $196,830 at $10.00 per person for a total commission. As stated above, the credit union receives $280.00 from each of the 19,683 investor members where for each person the credit union is splitting the money received $80.00 to purchase the grocery product, $100.00 directly to the credit union for infrastructure and $100.00 to the Compensation plan. The credit union uses the $100.00 Compensation plan to provide the primary investor member 300 and all subsequent investor members that gets other investor members $10.00 commission per month. [0030] Returning to FIG. 2B, at block 225, the 19.683 investor members each recruit three investor members for a total of 59,049 investor members as shown in level 10 (tenth set of investors) of the hierarchy of levels 303. (FIG. 3). When the 59,049 investor members are recruited each of them sends their payments through their own first computer 101 through the web interface 103 to the second computer 105 at the credit union. Thus, for recruiting the 59,049 investor members, the initial investor member 300 receives $590,490 at $10.00 per person for a total commission 307. As stated above, the credit union receives $280.00 from each of the 19.683 investor members where for each person the credit union is splitting the money received $80.00 to purchase the grocery product, $100.00 directly to the credit union for infrastructure and $100.00 to the Compensation plan. The credit union uses the $100.00 Compensation plan to provide the primary investor member 300 and all subsequent investor members that gets other investor members $10.00 commission per month.

Thus, if an initial investor member's hierarchy stretches to level 10 in the example shown, the initial investor 300 will have amassed $885,720 in commissions. When the investor member 300 has 500 people below him he is at the “shepherd” level 309. As stated above, the shepherd level as shown in FIG. 3 occurs between the levels of 5 and 6. Since this investor member 300 has 500 people below him he'll be earning $5000.00 a month, where the 500 people are paying $280.00 each where the $100.00 is used as part of the compensation plan. From this compensation plan $10.00 is taken out from subsequent investor member monthly fee and paid to the investor member at the shepherd level. The commission structure gives an incentive to investors to promote the membership benefits of the cooperative investment program, while it benefits the participating merchants by increasing the number of consumers who will become the merchant's customers. The more people that are investment members the more merchants will be willing to participate in the venture.

The initial investor member at the shepherd level for groceries having an additional investment cross-cooperates with a shepherd level investor member for men/women and children where the shepherd level investor member for groceries can cross-cooperate with the shepherd level investor member for men/women and children apparel to become a shepherd level investor member for groceries and men/women and children apparel and vice versa. This crosscooperation may be for marketing and recruiting to help the investor member at the shepherd level for groceries obtain investing members to become a shepherd level member for men/women and children apparel and vice versa. Thus, the force matrix for the investor member at shepherd level for groceries is now under the investor member at shepherd level for men/women and children apparel and vice versa. When the shepherd level investor member at groceries becomes a shepherd level for men/women and children apparel then this shepherd level investor member can obtain 70 investing members with accompanying 3 customer members where the 3 customer members can pay a $50.00 fee to use 25-50% discounts in the grocery department and the men/women and children department. Next, after the investor members and customer members the cooperative store allow regular people to shop at the store where they will receive a discount in the range of 10-15% off of purchased products.

Next, the investor member at the shepherd level for groceries and men/women and children apparel for groceries and for men/women and children apparel can cross-cooperate with the shepherd level investor member for computer electronics where the shepherd level investor member for groceries and men/women and children apparel can help the shepherd level investor member for computer electronics become a shepherd level investor member for groceries and men/women and children and vice versa. This help may be marketing and recruiting to help the investor member at the shepherd level for groceries and men/women and children apparel obtain investing members to become a shepherd level member for computer electronics. Thus, the force matrix for the investor member at the shepherd level for groceries and men/women and children is now under the investor member at the shepherd level for computer electronics and vice versa. When the shepherd investor member at groceries and men/women and children becomes a shepherd level for computer electronics then this shepherd level investor member can obtain 70 investing members with accompanying 3 customer members where the 3 customer members can pay a $75.00 fee to use 25-50% discounts in the grocery department, men/women and children department and computer electronics department. Next, after the investor members and customer members the cooperative store allow regular people to shop at the store where they will receive a discount in the range of 10-15% off of purchased products.

Next, the initial investor member at the shepherd level for groceries, men/women and children apparel and computer electronics can cross-cooperate with the shepherd level investor member for automobiles where the shepherd level investor member for groceries, for men/women and children apparel and computer electronics can help the shepherd level investor member for the auto department become a shepherd level investor member for groceries, men/women and children apparel. This cross-cooperation may be marketing and recruiting to help the investor member at the shepherd level for groceries, for men/women and children, for computer electronics obtain investing members to become a shepherd level member for Autos. When the shepherd investor member at groceries, men/women and children apparel, computer electronics becomes a shepherd level investor member for Autos then this shepherd level investor member can obtain 70 investor member with accompanying 3 customer members where the 3 customer members can pay a $100.00 fee to use 25-50% discounts in the grocery, men/women and children apparel, computer electronics and Auto departments. Next, after the investor members and customer members the cooperative store allow regular people to shop at the store where they will receive a discount in the range of 10-15% off of purchased products.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the disclosed technology.

What is claimed is:

1. A computer implemented method for using a force matrix to invest in a property of wholesale goods, the method comprising:
receiving an initial payment from an investor member;
distributing the initial payment to an investment structure for the property of wholesale goods in at least one department of an investment cooperative store that includes a category for a plurality of products, a category for a credit union and a category for compensation;
transmitting a plurality of payments from a first set of investors based on the force matrix to the at least one department of the investment cooperative store; distributing the plurality of payments from the first set of investors based on the force matrix to the investment structure for the property of wholesale consumer goods in the at least one department; transmitting a plurality of payments from a second set of investors based on the force matrix to the at least one department of the investment cooperative store: distributing the plurality of payments from the second set of investors based on the force matrix to the investment structure for the property of wholesale goods in the at least one department;
transmitting a plurality of payments from a third set of investors based on the force matrix to the at least one department of the investment cooperative store;
distributing the plurality of payments from the third set of investors based on the force matrix to the investment structure for the property of wholesale goods in the at least one department;
transmitting a plurality of payments from a fourth set of investors based on the force matrix to the at least one department of the investment cooperative store; and
distributing the plurality of payments from the fourth set of investors based on the force matrix to the investment structure for the property of wholesale goods in the at least one department.

2. The computer implemented method of claim 1 wherein the at least one department is a grocery department.

3. The computer implemented method of claim 2 wherein the at least one department is a Men/women and children apparel department.

4. The computer implemented method of claim 1 further comprising:
transmitting a fee to the investor member from the category of the compensation plan.

5. The computer implemented of claim 1 further comprising:
transmitting a plurality of payments from a fifth set of investors based on the force matrix to the at least one department of the investment cooperative store; and
distributing the plurality of payments from the fifth set of investors based on the force matrix to the investment structure for the property of wholesale goods in the at least one department.

6. The computer implemented method of claim 5, further comprising:
transmitting a plurality of payments from a sixth set of investors based on the force matrix to the at least one department of the investment cooperative store; and
distributing the plurality of payments from the sixth set of investors based on the force matrix to the investment structure for the property of wholesale goods in the at least one department.

7. The computer implemented method of claim 1, wherein the at least one department is from the group comprising a grocery department, a men/women and children apparel department, a computer electronics department and an auto department.
